(19) United States
(12) Patent Application Publication
(10) Pub. No.: US 2025/0310444 A1
(43) Pub. Date: Oct. 2, 2025

(54) INFORMATION PROCESSING SYSTEM, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventors: Hisao KOMAZAWA, Kanagawa (JP); Akiho YASUDA, Kanagawa (JP)

(73) Assignee: FUJIFILM Business Innovation Corp., Tokyo (JP)

(21) Appl. No.: 18/780,490

(22) Filed: Jul. 23, 2024

(30) Foreign Application Priority Data
Mar. 27, 2024 (JP) 2024-052306

(51) Int. Cl. H04N 1/00; H04N 1/23

(52) U.S. Cl. CPC H04N 1/00082; H04N 1/00015; H04N 1/00029; H04N 1/00633; H04N 1/2338

(57) ABSTRACT

An information processing system includes a processor configured to inspect a printing quality of a printed material and perform continuous printing of a subsequent printed material, discharge a printed material having an inspection result of fail and a printed material printed until printing is stopped after the printed material having the inspection result of fail, as failed printed materials, to a first discharge unit, discharge a printed material having an inspection result of pass to a second discharge unit, and discharge a printed material to which an instruction of sample printing is given, as sample printing, to the first discharge unit, in a case where the instruction is received.

### CROSS-REFERENCE TO RELATED APPLICATIONS

This application is based on and claims priority under 35 USC 119 from Japanese Patent Application No. 2024-052306 filed Mar. 27, 2024.

### BACKGROUND

### (i) Technical Field

The present invention relates to an information processing system, a non-transitory computer readable medium storing an information processing program, and an information processing method.

### (ii) Related Art

JP2022-124459A discloses a printing system that inspects a printed sheet, including a printing device that prints an image on a sheet, an inspection device that receives and inspects the sheet printed and transported by the printing device, and an information processing apparatus, in which the information processing apparatus includes a determination unit that determines whether or not there is a device having a paper discharge tray between the printing device and the inspection device, and a control unit that, in a case where the determination unit determines that the device is present, performs control such that the sheet printed by the sample printing is discharged to the paper discharge tray, at a timing of sample printing at which a user checks the printing on the sheet during execution of a print job using the printing device and the inspection device.

JP2022-146528A discloses an inspection device that inspects a printed material by comparing a standard image with a printed material that has been printed, the inspection device including a control unit that exclusively controls, as the inspection mode of the inspection, a mode for switching the paper discharge destination of a printed material in which a defect is found, and an inspection job for inspecting a printed material, with a plurality of printed materials as one set, or an inspection type for inspecting printed materials having an order.

JP2022-107439A discloses an image forming system including an image forming unit that executes a print job to form an image on a supplied sheet, and an inspection unit that inspects a quality of the image formed on the sheet, in which the inspection unit does not set the sheet which is not used for a print job and discharged by the image forming unit as an inspection target.

### SUMMARY

Aspects of non-limiting embodiments of the present disclosure relate to an information processing system, a non-transitory computer readable medium storing an information processing program, and an information processing method that perform sample printing such that a printing state can be visually checked even in a case of continuous printing while inspecting printing quality.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a processor configured to: inspect a printing quality of a printed material and perform continuous printing of a subsequent printed material; discharge a printed material having an inspection result of fail and a printed material printed until printing is stopped after the printed material having the inspection result of fail, as failed printed materials, to a first discharge unit; discharge a printed material having an inspection result of pass to a second discharge unit; and discharge a printed material to which an instruction of sample printing is given, as sample printing, to the first discharge unit, in a case where the instruction is received.

### BRIEF DESCRIPTION OF THE DRAWINGS

Exemplary embodiment(s) of the present invention will be described in detail based on the following figures, wherein:

FIG. 1 is a diagram showing a schematic configuration of an image forming system according to an exemplary embodiment;

FIG. 2 is a diagram illustrating an operation of the image forming system shown in FIG. 1 (Part 1);

FIG. 3 is a diagram illustrating the operation of the image forming system shown in FIG. 1 (Part 2);

FIG. 4 is a block diagram showing a hardware configuration of the image forming system shown in FIG. 1;

FIG. 5 is a functional block diagram of the image forming system shown in FIG. 1;

FIG. 6 is a diagram illustrating an operation of sample printing of the image forming system shown in FIG. 1 (Part 1);

FIG. 7 is a diagram illustrating the operation of sample printing of the image forming system shown in FIG. 1 (Part 2);

FIG. 8 is a diagram illustrating the operation of sample printing of the image forming system shown in FIG. 1 (Part 3);

FIG. 9 is a diagram illustrating the operation of sample printing of the image forming system shown in FIG. 1 (Part 4);

FIG. 10 is a diagram illustrating the operation of the sample printing of the image forming system shown in FIG. 1 (Part 5);

FIG. 11 is a diagram illustrating the operation of sample printing of the image forming system shown in FIG. 1 (Part 6);

FIG. 12 is a diagram illustrating the operation of sample printing of the image forming system shown in FIG. 1 (Part 7);

FIG. 13 is a diagram showing a schematic configuration of a printing system 1 according to an exemplary embodiment;

FIG. 14 is an example of a purge setting screen; and

FIG. 15 is a flowchart showing a flow of a sample printing process of the image forming system shown in FIG. 1.

### DETAILED DESCRIPTION

Hereinafter, an exemplary embodiment will be described with reference to the drawings.

### Overview of Image Forming System

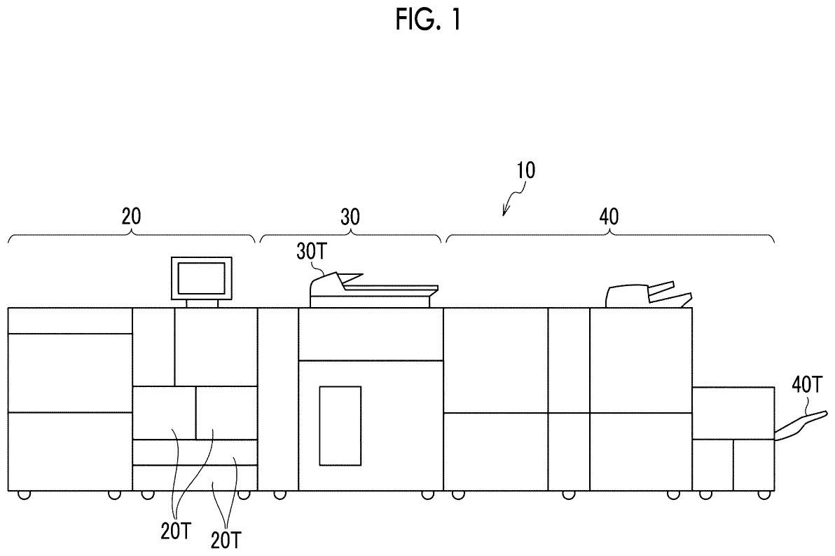

FIG. 1 shows an image forming system 10 according to an exemplary embodiment. The image forming system 10 includes a printing device 20, an inspection device 30, and a post-processing device 40. The image forming system 10 is an example of an information processing system and an information processing apparatus.

### Printing Device

The printing device 20 includes a plurality of accommodation trays 20T for accommodating paper. The printing device 20 has a printing function of printing an image on paper supplied from any accommodation tray 20T, among the plurality of accommodation trays 20T. The paper is an example of a recording medium, and the accommodation tray 20T is an example of an accommodation unit.

### Inspection Device

The inspection device 30 has an inspection function of receiving the paper on which the image is printed from the printing device 20 and inspecting the printing quality of the received printed paper (printed material). The inspection device 30 determines whether or not there is an abnormality such as corner folding, contamination of printing, or misalignment in the printed material received from the printing device 20.

Specifically, the inspection device 30 includes a purge tray 30T that discharges the printed material. The inspection device 30 receives a standard image (normal image), such as a rasterized image, generated on the basis of image data to be printed on the paper, from the printing device 20. In addition, the inspection device 30 scans the image of the printed material received from the printing device 20. Then, the inspection device 30 collates the standard image received from the printing device 20 with an inspection image such as a rasterized image based on the scanned image and determines whether or not there is an abnormality in the printed material.

As a result, in a case where it is determined that there is an abnormality in the printed material, the inspection device 30 sets the inspection result to fail and discharges the printed material to the purge tray 30T. On the other hand, in a case where it is determined that there is no abnormality in the printed material, the inspection device 30 supplies the printed material into the post-processing device 40 by setting the inspection result as pass. The purge tray 30T is an example of a first discharge unit.

### Post-Processing Device

The post-processing device 40 executes various types of post-processes, such as a folding process, a stapling process, a punch hole process, and a booklet making process, on the printed material inspected by the inspection device 30, and discharges the post-processed printed material into the predetermined discharge tray 40T. The processing contents of the post-processing device 40 can be changed as appropriate. In addition, the discharge tray 40T is an example of a second discharge unit.

### Continuous Printing

The image forming system 10 has a continuous printing function. In this continuous printing, for example, a plurality of continuous printed materials are continuously printed while the printing quality is inspected. Specifically, in the continuous printing, the printing device 20 prints the image on each of the plurality of sheets of paper supplied in sequence from the accommodation tray 20T, and the inspection device 30 sequentially inspects the printed material on which the image is printed. In the inspection device 30, the printed material having the inspection result of pass is subjected to post-processing in the post-processing device 40 and is discharged into the predetermined discharge tray 40T.

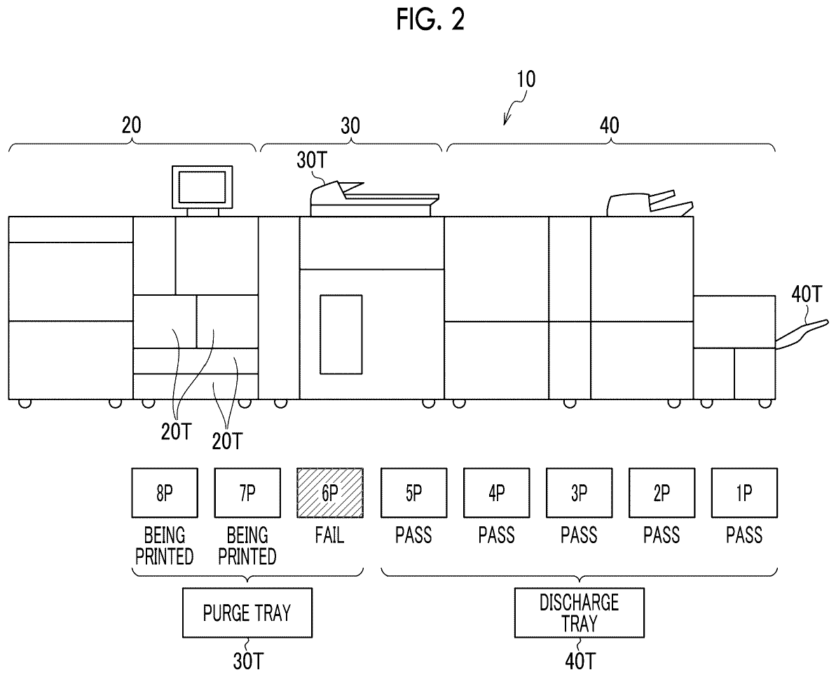

Here, as shown in FIG. 2, during continuous printing, in a case where a printed material having an inspection result by the inspection device 30 of fail is generated (printed material of 6P), not only the printed material having the inspection result of fail but also the printed materials (printed materials of 7P and 8P) during printing following the printed material, that is, all the sheets of paper on the paper transport path from the accommodation tray 20T to the inspection by the inspection device 30 are discharged to the purge tray 30T.

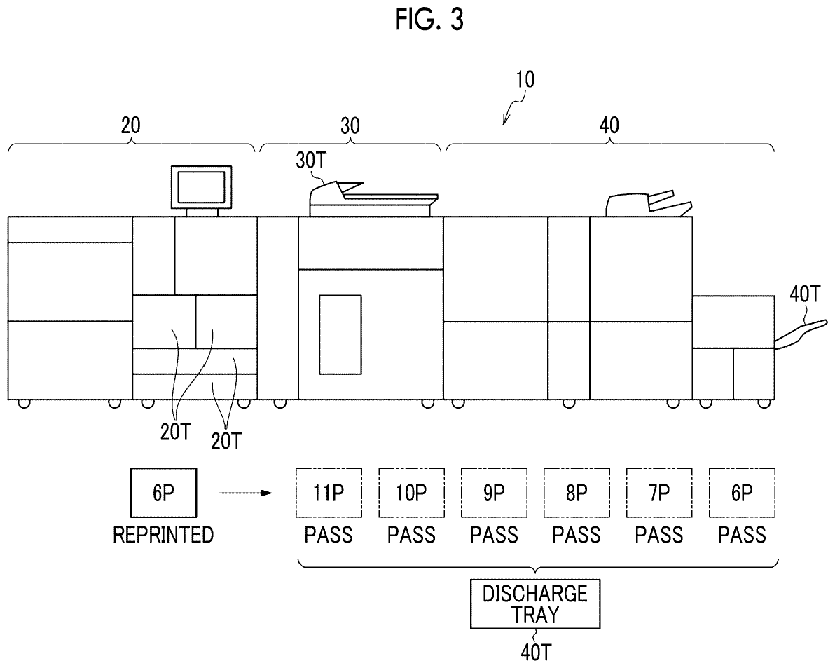

Thereafter, as shown in FIG. 3, the continuous printing (reprinting) is resumed from the printed material (printed material of 6P) having the inspection result by the inspection device 30 of fail. Then, as shown by the two-dot chain line in FIG. 3, the reprinted material (printed material of 6P) having an inspection result by the inspection device 30 of pass and the subsequent printed materials (printed materials of 7P to 11P) following the reprinted material are discharged to the discharge tray 40T of the post-processing device 40. In a case where a printed material having an inspection result by the inspection device 30 of fail is generated, only the printed material having the inspection result of fail (printed material of 6P) is discharged to the purge tray 30T, and in a case where the printed materials (printed materials of 7P and 8P) during printing following the failed printed material are discharged to the discharge tray 40T of the post-processing device 40, the page order of the printed materials is shifted in the discharge tray 40T.

In addition, the image forming system 10 has a sample printing function. In this sample printing, for example, among a plurality of continuous printed materials, a printed material obtained by duplicating a designated printed material is discharged to the purge tray 30T, and the printing quality is visually checked. Specifically, in the sample printing, when a sample button is pressed from the input unit 58, the printing device 20 discharges the printed material before discharging to the purge tray 30T.

However, in the image forming system 10 in the related art, sample printing is prohibited for printing accompanied by inspection.

Therefore, the image forming system 10 according to the present exemplary embodiment inspects a printing quality of a printed material and performs continuous printing of a subsequent printed material, discharges a printed material having an inspection result of fail and a printed material printed until printing is stopped after the printed material having the inspection result of fail, as failed printed materials, to a first discharge unit, discharges a printed material having an inspection result of pass to a second discharge unit, and discharges a printed material to which an instruction of sample printing is given, as sample printing, to the first discharge unit, in a case where the instruction is received. Hereinafter, the image forming system 10 according to the present exemplary embodiment will be described in detail.

### Hardware Configuration of Image Forming System

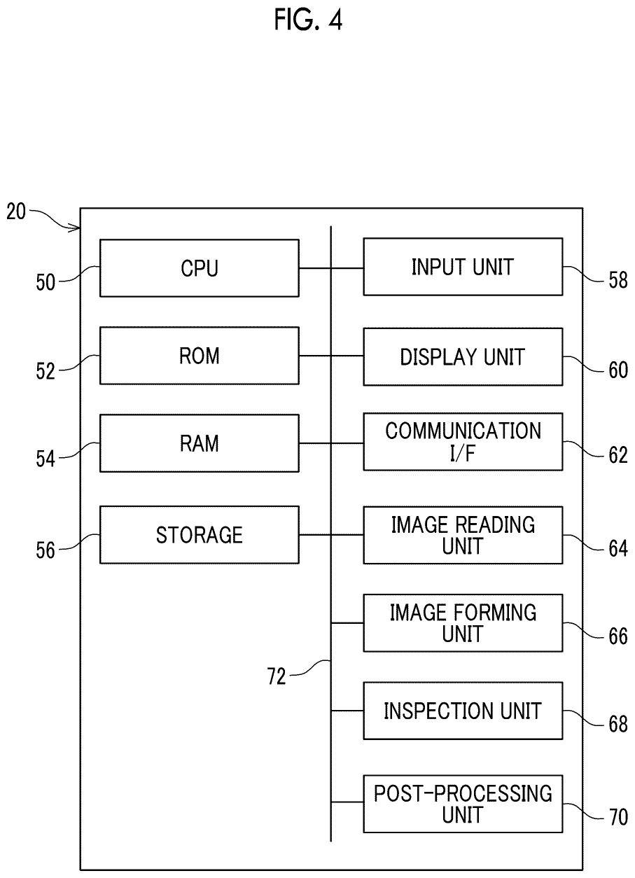

First, a hardware configuration of the image forming system 10 will be described. It should be noted that, in the following, for convenience of description, a hardware configuration of the image forming system 10 will be described, but the printing device 20, the inspection device 30, and the post-processing device 40 may separately include the hardware configuration as shown in FIG. 4.

As shown in FIG. 4, the image forming system 10 includes a computer including a central processing unit (CPU) 50, a read only memory (ROM) 52, a random access memory (RAM) 54, a bus 72, a storage 56, a communication interface (I/F) 62, and the like, and has components of an input unit 58, a display unit 60, an image reading unit 64, an image forming unit 66, an inspection unit 68, and a post-processing unit 70.

The CPU 50 is a central processing unit and executes various programs or controls each unit. That is, the CPU 50 reads out a program from the ROM 52 or the storage 56 and executes the program using the RAM 54 as a work area. The CPU 50 controls each of the above-described configurations and performs various types of arithmetic processing according to the program recorded on the ROM 52 or the storage 56. In addition, the CPU 50 is an example of a processor.

The ROM 52 stores various information processing programs and various types of data. The RAM 54 temporarily stores the program or the data as the work area of the CPU 50.

The storage 56 is configured with a hard disk drive (HDD) or a solid state drive (SSD), and stores various programs including an operating system and various types of data. In addition, the storage 56 stores a response processing program.

The input unit 58 includes an operation button or the like and is used to perform various inputs. The display unit 60 is, for example, a liquid crystal display and displays various types of information. The display unit 60 may be a touch panel type and may function as the input unit.

The communication I/F 62 is an interface for communication with other apparatuses. For example, a standard, such as Ethernet (Registered Trademark), FDDI, or Wi-Fi (Registered Trademark), is used.

The image reading unit 64 includes a scanner or the like and optically reads image data from a document or the like. The image forming unit 66 prints the image data read by the image reading unit 64 or the image data received from an operation terminal (not shown) on a recording medium such as paper.

The inspection unit 68 includes a scanner or the like, and optically reads image data from the paper (printed material) on which the image is printed by the image forming unit 66.

The post-processing unit 70 includes various post-processing mechanisms such as a folding processing mechanism of a recording medium such as paper, a stapling processing mechanism, a punch hole processing mechanism, and a booklet manufacturing processing mechanism, and performs a post-process on the printed material inspected by the inspection device 30.

### Function of Image Forming System

Next, functions of the image forming system 10 will be described.

In a case where the information processing program described above is executed, the image forming system 10 implements various functions of the printing device 20, the inspection device 30, and the post-processing device 40 by using the above hardware resources.

### Printing Device

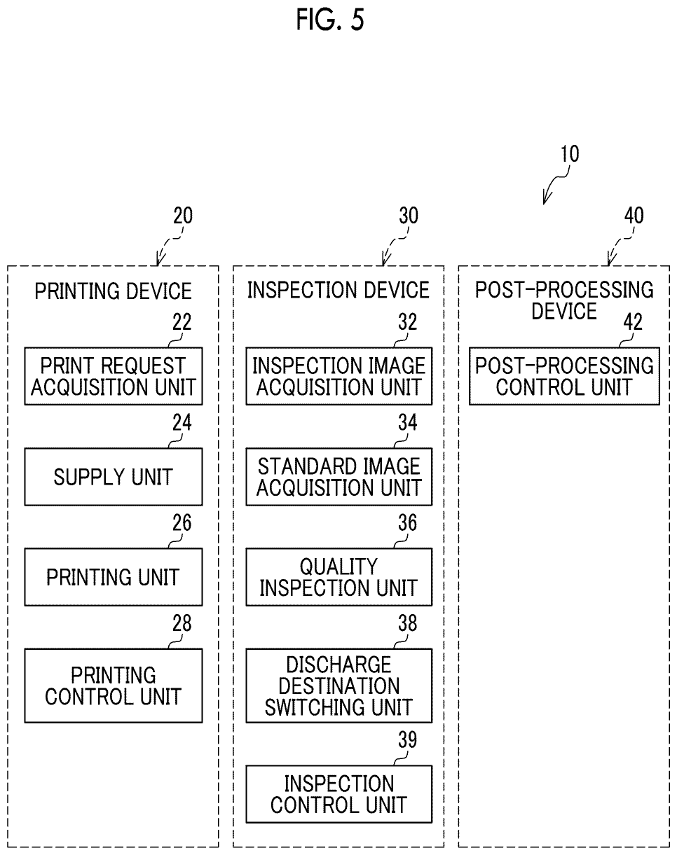

Specifically, as shown in FIG. 5, the printing device 20 functionally includes a print request acquisition unit 22, a supply unit 24, a printing unit 26, and a printing control unit 28.

The print request acquisition unit 22 acquires, for example, information (print data) of the print image input to the image forming system 10 or a print request (print job) such as a paper size and the number of printed sheets of paper.

The supply unit 24 supplies, to the printing unit 26, the paper accommodated in the predetermined accommodation tray 20T among the plurality of accommodation trays 20T. The printing unit 26 prints an image on the paper supplied from the supply unit 24.

### Inspection Function

The printing control unit 28 controls the overall operation of the printing device 20, and executes continuous printing in which an image is printed on each of a plurality of sheets of paper accommodated in the accommodation tray 20T and the plurality of printed materials are sequentially supplied to the inspection device 30.

Specifically, the printing control unit 28 controls the supply unit 24 based on the print request acquired by the print request acquisition unit 22 to sequentially supply the plurality of sheets of paper from the predetermined accommodation tray 20T to the printing unit 26 among the plurality of accommodation trays 20T. In addition, the printing control unit 28 transmits the print data to be printed on the plurality of sheets of paper to the printing unit 26. Then, the printing control unit 28 causes the printing unit 26 to print the image based on the print data on each of the plurality of sheets of paper supplied from the accommodation tray 20T, and sequentially supplies the plurality of printed materials from the printing unit 26 to the inspection device 30.

In addition, the printing control unit 28 transmits the print data for performing printing on each of the plurality of sheets of paper to an inspection control unit 39 in the inspection device 30 described below.

### Reprinting

For example, as shown in FIG. 2, in a case where in the inspection device 30, a printed material (printed material of 6P) having an inspection result of fail is generated, the printing control unit 28 stops the continuous printing of the printed material and executes reprinting of only the printed material (printed material of 6P) having an inspection result of fail.

Specifically, as shown in FIG. 3, the printing control unit 28 controls the supply unit 24 based on the inspection result received from the inspection control unit 39 described below, and supplies one sheet of paper from a predetermined accommodation tray 20T among the plurality of accommodation trays 20T to the printing unit 26. Then, the printing control unit 28 causes the printing unit 26 to reprint the image of which the inspection result is fail on one sheet of paper supplied from the accommodation tray 20T, and supplies the reprinted material (reprinted material of 6P) that is reprinted, from the printing unit 26 to the inspection device 30.

In a case where the inspection result of the reprinted material by the inspection device 30 is passed, the printing control unit 28 resumes the continuous printing of the subsequent printed materials following the reprinted material.

### Inspection Device

The inspection device 30 functionally includes an inspection image acquisition unit 32, a standard image acquisition unit 34, a quality inspection unit 36, a discharge destination switching unit 38, and an inspection control unit 39.

The inspection image acquisition unit 32 scans an image from a printed material printed by the printing unit 26, and generates an inspection image such as a rasterized image based on the scanned image.

The standard image acquisition unit 34 receives the print data or the test data transmitted from the printing control unit 28 as the standard image.

The quality inspection unit 36 compares the inspection image read by the inspection image acquisition unit 32 with the standard image received by the standard image acquisition unit 34 to determine whether or not there is an abnormality in the printed material, that is, whether the printing quality of the printed material is pass or fail.

Specifically, the quality inspection unit 36 compares the inspection image with a standard image to determine whether or not there is an abnormality such as a corner folding, printing contamination, or misalignment. In a case where it is determined that there is no abnormality in the printed material, the quality inspection unit 36 determines the printed material as pass. In a case where it is determined that there is an abnormality in the printed material, the quality inspection unit 36 determines the printed material as fail.

The discharge destination switching unit 38 switches the discharge destination of the printed material inspected by the quality inspection unit 36 between the post-processing device 40 and the purge tray 30T. In addition, a function of controlling a discharge position of the printed material of the purge tray 30T may be provided.

The inspection control unit 39 controls the operation of the entire inspection device 30. Specifically, the inspection control unit 39 causes the quality inspection unit 36 to inspect the printing quality of the printed material or the reprinted material. In a case where the printing quality of the printed material or the reprinted material is passed by the quality inspection unit 36, the inspection control unit 39 causes the discharge destination switching unit 38 to switch the discharge destination of the printed material or the reprinted material to the post-processing device 40.

On the other hand, in a case where the inspection result of the printed material or the reprinted material by the quality inspection unit 36 is fail, the inspection control unit 39 switches the discharge destination of the printed material or the reprinted material to the purge tray 30T by the discharge destination switching unit 38.

In addition, the inspection control unit 39 transmits information such as the inspection result by the quality inspection unit 36 and the number of pages (page numbers) of the printed materials determined to be failed to the printing control unit 28, and stores the information in the printing device 20.

### Post-Processing Device

The post-processing device 40 functionally includes a post-processing control unit 42. The post-processing control unit 42 controls the operation of the entire post-processing device 40. Specifically, the post-processing control unit 42 controls various post-processing mechanisms, such as a folding processing mechanism, a stapling processing mechanism, a punch hole processing mechanism, and a booklet making processing mechanism, and performs a post-process on the printed material supplied from the inspection device 30.

The printing control unit 28, the inspection control unit 39, and the post-processing control unit 42 control the overall operation of the image forming system 10 in cooperation with each other by transmitting and receiving information to and from each other.

### Sample Printing

In a case where an instruction for sample printing is received from the input unit 58, the printed material of the job being printed is set as a target of the sample printing. In addition, in a case where with a plurality of pieces of printed materials as one set, printing the plurality of pieces is set in a job in which sample printing is designated, one set is set as a target of the sample printing.

Whether or not to perform the sample printing on the job to be inspected is determined in accordance with the purge setting set for each job. In addition, a method of discharging a sample printing and a failed printed material are set in the purge setting. Specifically, a case where blank paper is discharged between the sample printing and the failed printed material and a case where the discharge positions of the sample printing and the failed printed material are made different from each other for separation between the sample printing and the failed printed material are set in the purge setting.

The inspection control unit 39 switches the discharge destination of the printed material included in the one set that is a target of the sample printing to the purge tray 30T and discharges the printed material, and switches the discharge destination of the remaining printed materials to the discharge tray 40T by the discharge destination switching unit 38 and discharges the remaining printed materials.

In addition, the printed material included in the target of the sample printing is also to be inspected. Therefore, the inspection control unit 39 causes the quality inspection unit 36 to inspect the printing quality of the printed material of the sample printing, but the printed materials of the sample printing, of which printing quality is pass and printing quality is fail, are discharged onto the purge tray 30T. In addition, for the printed material of the sample printing, the inspection results such as the number of pages and the page number of the printed materials determined to be failed are transmitted to the printing control unit 28 and stored in the printing device 20.

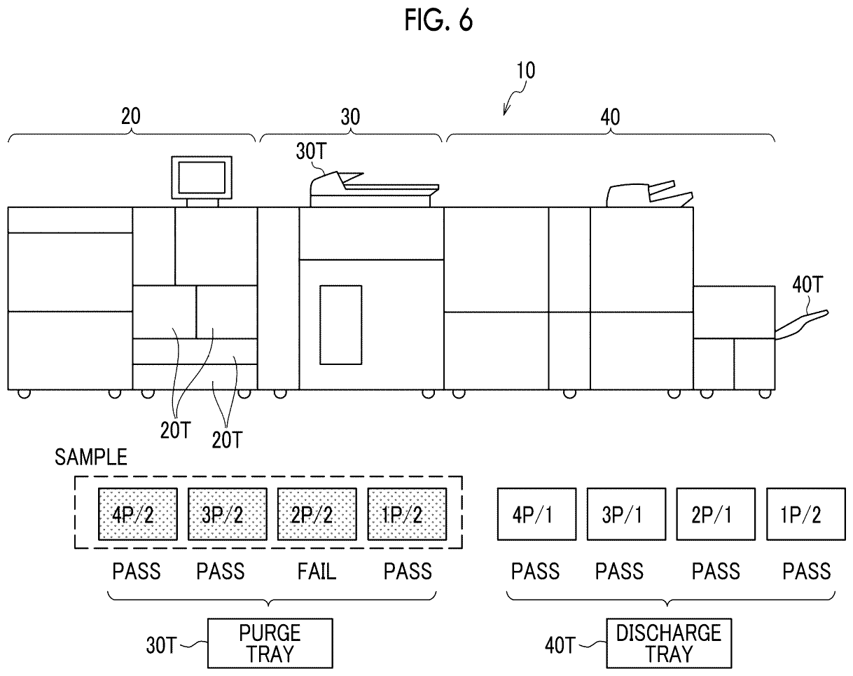

As shown in FIG. 6, in the inspection device 30, with respect to a first set of printed materials that is not the target of the sample printing, the printed materials (1P/1 to 4P/1) having an inspection result of pass are discharged to the discharge tray 40T, and with respect to a second set of printed materials that is the target of the sample printing (printed materials surrounded by a broken line in FIG. 6), the printed materials (1P/2, 3P/2, and 4P/2) having an inspection result of pass and the printed material (2P/2) having an inspection result of fail are discharged to the purge tray 30T.

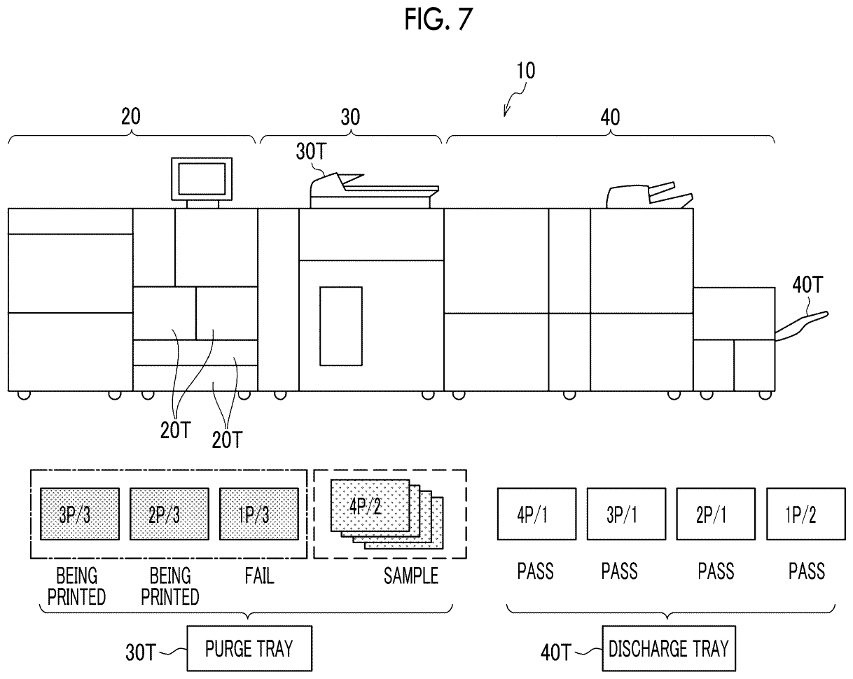

Subsequently, as shown in FIG. 7, after the sample printing is discharged to the purge tray 30T, in a case where a third set of printed materials that is not the target of the sample printing has a printed material having the inspection result of fail, not only the printed material having the inspection result of fail (1P/3) but also the printed materials (printed materials of 2P/3 and 3P/3) being printed following the failed printed material are discharged to the purge tray 30T as failed printed materials (that is, all sheets of paper (printed materials surrounded by one-dot chain line in FIG. 7) present in the paper transport path from the accommodation tray 20T to the inspection by the inspection device 30).

Since both the printed material of the sample printing and the failed printed material are discharged to the purge tray 30T, in a case where the printed material of the sample printing and the failed printed material are stacked and discharged to the purge tray 30T, the failed printed material is stacked on the printed material of the sample printing, so that it is difficult to distinguish between the printed material of the sample printing and the failed printed material.

Therefore, the sample printing and the failed printed material are discharged to the purge tray 30T according to the discharge method set in the purge setting. First, a case where blank paper is discharged as separation between the sample printing and the failed printed material will be described.

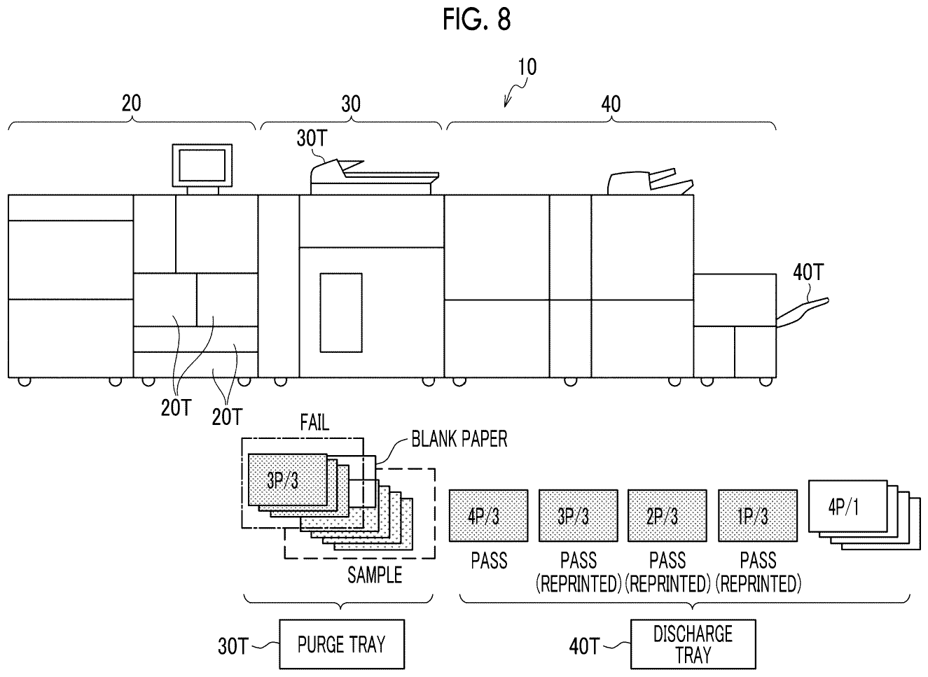

As shown in FIG. 8, in a case where the printed material of the sample printing (printed material surrounded by a broken line) is discharged to the purge tray 30T before the failed printed material (printed material surrounded by a dotted line), the inspection device 30 discharges blank paper to the purge tray 30T, between the printed material of the sample printing and the failed printed material. That is, the blank paper is discharged to the purge tray 30T, onto the printed material of the sample printing, and then the failed printed material is discharged to the purge tray 30T.

Thereafter, the continuous printing (reprinting) is resumed from the printed material (1P/3) having the inspection result by the inspection device 30 of fail. Then, the reprinted materials (1P/3 to 3P/3) having an inspection result by the inspection device 30 of pass and the subsequent printed material (4P/3) following the reprinted materials are discharged to the discharge tray 40T by switching the discharge destination by the discharge destination switching unit 38.

Although the case where the printed material having the inspection result of fail is generated in the third set following the sample printing of the second set is illustrated in FIGS. 7 and 8, even in a case where a printed material having the inspection result of fail is generated after the passed printed material is discharged to the discharge tray 40T after the sample printing is completed, in a case where the printed material of the sample printing is discharged to the purge tray 30T, the failed printed material is discharged to the purge tray 30T after blank paper is discharged to the purge tray 30T. By discharging the blank paper between the sample printing and the failed printed material in this way, the separation between the sample printing and the failed printed material becomes easier to see.

Next, a case where the printed material of the sample printing is discharged to the purge tray 30T after discharging the printed material that has failed the inspection to the purge tray 30T will be described.

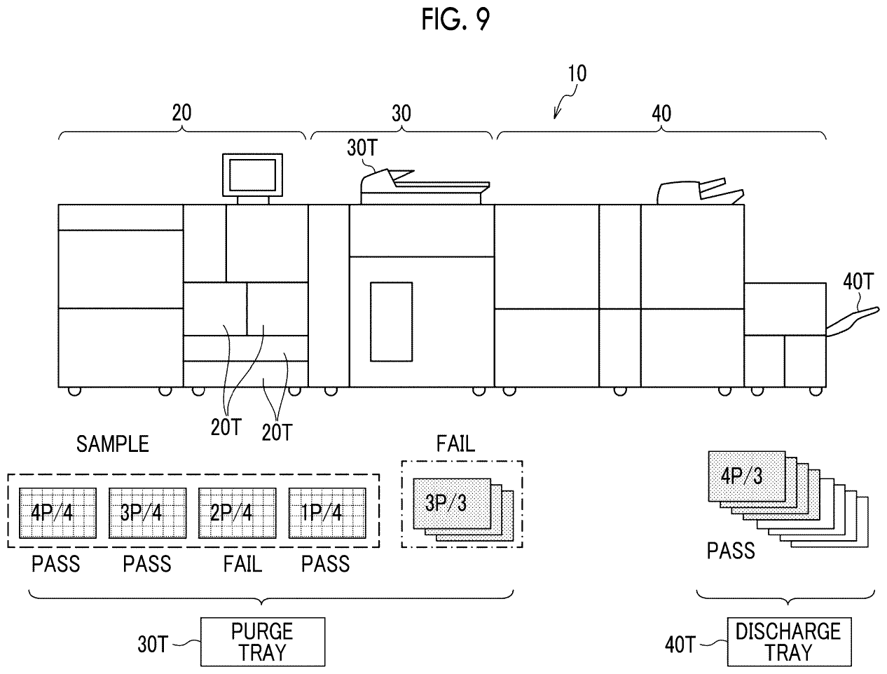

As shown in FIG. 9, by the inspection device 30, the failed printed materials (printed materials surrounded by a broken line) are discharged to the purge tray 30T, and the reprinted materials (1P/3 to 3P/3) having the inspection result of pass and the subsequent printed material (4P/3) following the reprinted materials are discharged to the discharge tray 40T by switching the discharge destination by the discharge destination switching unit 38. Next, in a case where a fourth set of printed materials (1P/4 to 4P/4) is the target of the sample printing, the fourth set of printed materials is discharged to the purge tray 30T by switching the discharge destination by the discharge destination switching unit 38.

In this case, since both the failed printed material and the printed material of the sample printing are discharged to the purge tray 30T, in a case where the printed materials are stacked and discharged to the purge tray 30T, the printed material of the sample printing is stacked on the failed printed material, so that it is difficult to distinguish between the failed printed material and the printed material of the sample printing.

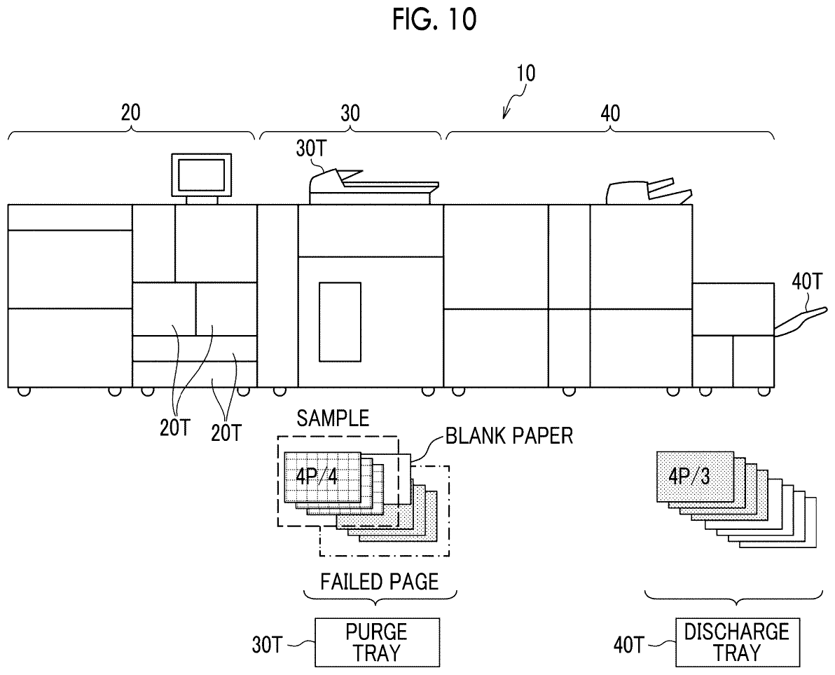

Therefore, as shown in FIG. 10, in a case where the failed printed materials (printed materials surrounded by a one-dot chain line) are discharged to the purge tray 30T before the printed materials of the sample printing (printed materials surrounded by a broken line), the inspection device 30 discharges blank paper to the purge tray 30T, between the failed printed material and the printed material of the sample printing. That is, the blank paper is discharged to the purge tray 30T, onto the failed printed material discharged to the purge tray 30T, and then the printed material of the sample printing is discharged to the purge tray 30T.

Although the case where the sample printing is performed on the fourth set of printed materials following the printed materials having the inspection result of fail in the third set is illustrated in FIGS. 9 and 10, even in a case where the printed material of the sample printing is discharged to the purge tray 30T after the passed printed material is discharged to the discharge tray 40T following the reprinting of the third set, in a case where the failed printed material is discharged to the purge tray 30T, the printed material of the sample printing is discharged to the purge tray 30T after blank paper is discharged to the purge tray 30T. By discharging the blank paper between the failed printed material and the printed material of the sample printing in this way, the separation between the failed printed material and the printed material of the sample printing becomes easier to see.

Although the case where blank paper is interposed between the printed material of the sample printing and the printed material having the inspection result of fail, and the printed material of the sample printing and the printed material having the inspection result of fail are discharged to the purge tray 30T is illustrated In FIGS. 7 to 10, next, a case where the discharge positions are different from each other at the separation between the printed material of the sample printing and the failed printed material will be described.

Specifically, in a case where the failed printed material is discharged to the purge tray 30T before the printed material of the sample printing, the discharge destination switching unit 38 makes the position at which the printed material of the sample printing is discharged to the purge tray 30T different from the position of the failed printed material discharged to the purge tray 30T. For example, the discharge position for discharging the printed material of the sample printing is offset in a direction intersecting the discharge direction and the loading direction of the printed material of the purge tray 30T to discharge the printed material of the sample printing. For example, the position is shifted to the right by 3 cm from the discharge position of the failed printed material in the discharge direction.

Alternatively, in a case where the printed material of the sample printing is discharged to the purge tray 30T before the failed printed material, the discharge destination switching unit 38 makes the position at which the failed printed material is discharged to the purge tray 30T different from the position of the printed material of the sample printing discharged to the purge tray 30T. For example, the discharge position for discharging the failed printed material is offset in a direction intersecting the discharge direction and the loading direction of the printed material of the purge tray 30T to discharge the failed printed material. For example, the discharge position is shifted by 3 cm to the left from the discharge position of the printed material of the sample printing in the discharge direction.

By moving the discharge position in the opposite direction in a case where the failed printed material is discharged to the purge tray 30T before the printed material of the sample printing and in a case where the printed material of the sample printing is discharged to the purge tray 30T before the failed printed material, the printed material of the sample printing and the failed printed material are stacked on each other at the same position, so that it is easy to distinguish the printed material of the sample printing from the failed printed material.

Although the case where the discharge position is moved in the opposite direction in a case where the failed printed material is discharged to the purge tray 30T before the printed material of the sample printing and in a case where the printed material of the sample printing is discharged to the purge tray 30T before the failed printed material has been described above, the discharge position may be moved in the same direction always, even in a case where the failed printed material is discharged to the purge tray 30T before the printed material of the sample printing and in a case where the printed material of the sample printing is discharged to the purge tray 30T before the failed printed material. By moving the discharge position of the purge tray 30T between the printed material having the inspection result of fail and the printed material of the sample printing in this way, the separation between the failed printed material and the printed material of the sample printing becomes easier to see.

Reprinting of Sample Printing

Next, a reprinting method when the second set of printed materials following the printed materials having the inspection result of fail of the first set are discharged to the purge tray 30T as the failed printed materials, in a case where the second set of printed materials following the first set of printed materials is a target of sample printing will be described.

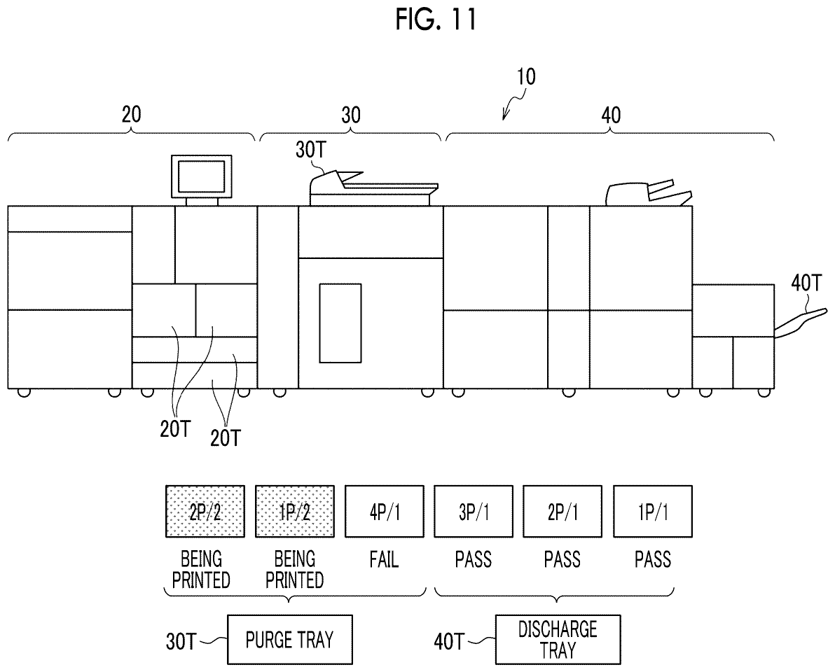

As shown in FIG. 11, in the inspection device 30, in a case where the printed material (4P/1) of the first set having the inspection result of fail is generated, the printed materials (1P/2 and 2P/2) in the second set being printed in the paper transport path following the printed material are discharged to the purge tray 30T as the failed printed materials.

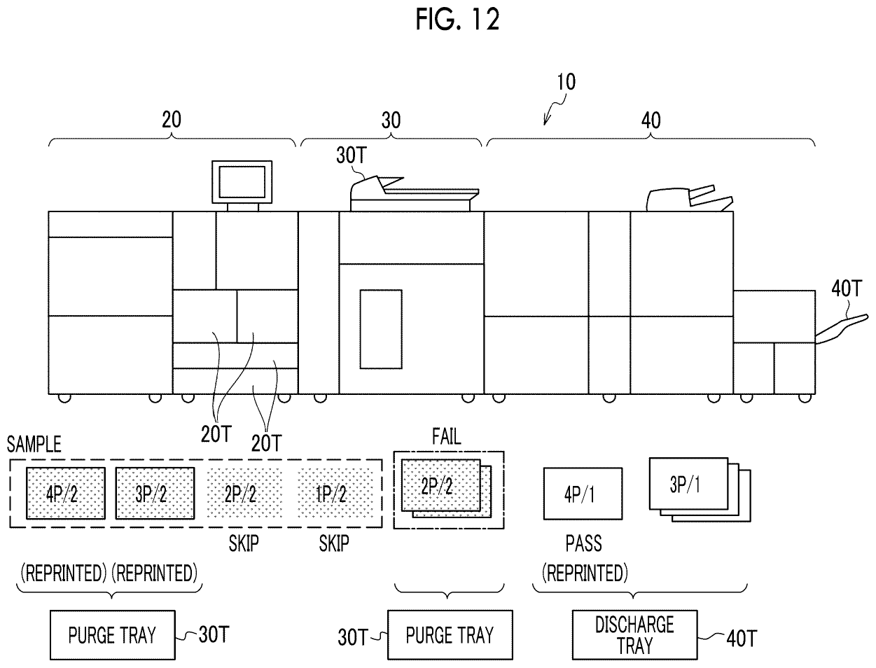

Thereafter, as shown in FIG. 12, the continuous printing (reprinting) is automatically resumed from the printed material (4P/1) having the inspection result by the inspection device 30 of fail. After the resumption, the reprinted material (4P/1) having the inspection result by the inspection device 30 of pass is discharged to the discharge tray 40T. Subsequently, the second set of printed materials is also targeted for continuous printing. Since the second set of printed materials is a target of the sample printing, the second set of printed materials is discharged to the purge tray 30T, but since the two printed materials (1P/2 and 2P/2) at the beginning of the second set are already included in the failed printed material, the two printed materials (1P/2and 2P/2) are already discharged to the purge tray 30T.

Therefore, only in a case where the second set of printed materials for which the sample printing is instructed is not included in the failed printed material, the second set of printed materials is discharged to the purge tray 30T as the sample printing. As shown in FIG. 12, the reprinting of the first two printed materials (1P/2 and 2P/2) of the second set is skipped, and the sample printing is resumed from the printed material (3P/2) following the printed material (2P/2) that is finally discharged to the purge tray 30T to discharge the printed material to the purge tray 30T.

In such a manner, in a case where the continuous printing is automatically resumed, the continuous printing is resumed except for the printed material discharged to the purge tray 30T among the printed materials of the sample printing. Thus, the number of printed materials is reduced without discharging a plurality of printed materials of the same sample printing.

### Printing System

Next, a printing system 1 according to an exemplary embodiment will be described.

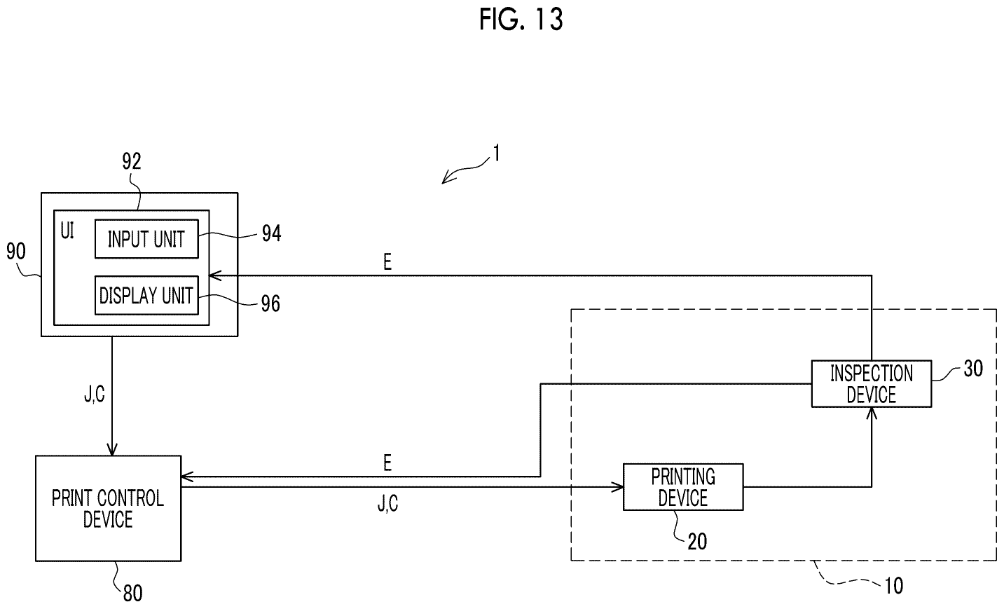

As shown in FIG. 13, the printing system 1 includes an image forming system 10, a print control device 80, and a user terminal 90. The print control device 80 is a computer having a server function and is communicably connected to the image forming system 10 and the user terminal 90 via a network. As the network, for example, a standard such as Ethernet (registered trademark), FDDI, or Wi-Fi (registered trademark) is used. While only one image forming system 10 and one user terminal 90 are shown in FIG. 13, a plurality of image forming systems 10 and a plurality of user terminals may be configured to be connected to the print control device 80.

The user terminal 90 is a computer having a communication function, and includes an input unit 94 and a display unit 96. The input unit 94 includes an operation button or the like and is used to perform various inputs. The display unit 96 is, for example, a liquid crystal display and displays various types of information. The display unit 96 may be a touch panel type and may function as the input unit 94.

The print control device 80 receives job J from the user terminal 90 and performs control for transmitting the received job J to the image forming system 10.

In addition, the print control device 80 transmits a print condition C set in the user terminal 90 to the corresponding image forming system 10. The print condition C includes whether or not the job is to be inspected and a purge setting regarding a discharge method of sample printing.

The image forming system 10 receives the job J transmitted from the print control device 80 in the print request acquisition unit 22 of the printing device 20 and starts the printing process. In addition, the image forming system 10 stores the print condition C transmitted from the print control device 80 and executes the printing process in accordance with the setting of the print condition C.

The inspection result R performed by the inspection device 30 of the image forming system 10 is transmitted to the print control device 80, and the printing result R is stored in the print control device 80 in association with each job J. In addition, in a case where the printing result R is fail, the error information E is transmitted to the user terminal 90. The error information E may be transmitted to the user terminal 90 via the print control device 80, but in a case where the image forming system 10 and the user terminal 90 are directly connected to each other, the error information E may be directly transmitted from the image forming system 10 to the user terminal 90.

The user terminal 90 is provided with a user interface (UI) 92. The UI 92 is configured with an input unit 94 and a display unit 96, and is used to input the job J and the print condition C. In addition, the job J and the print condition C input from the UI 92 are transmitted from the user terminal 90 to the print control device 80. In addition, the user terminal 90 displays the error information E transmitted from the inspection device 30 on the UI 92.

Since the error information E includes the inspection results such as the number of pages and the page numbers of the printed materials determined to be failed among the printed materials, the user can check whether or not the printed materials determined to be failed are included in the printed materials subject to sample printing, by the UI 92 of the user terminal 90. Alternatively, the inspection result stored in the printing device 20 may be displayed on the display unit 60 of the image forming system 10 such that the user can check the inspection result.

### Setting of Inspection Purge

Next, a method of setting the purge of the job to be inspected will be described.

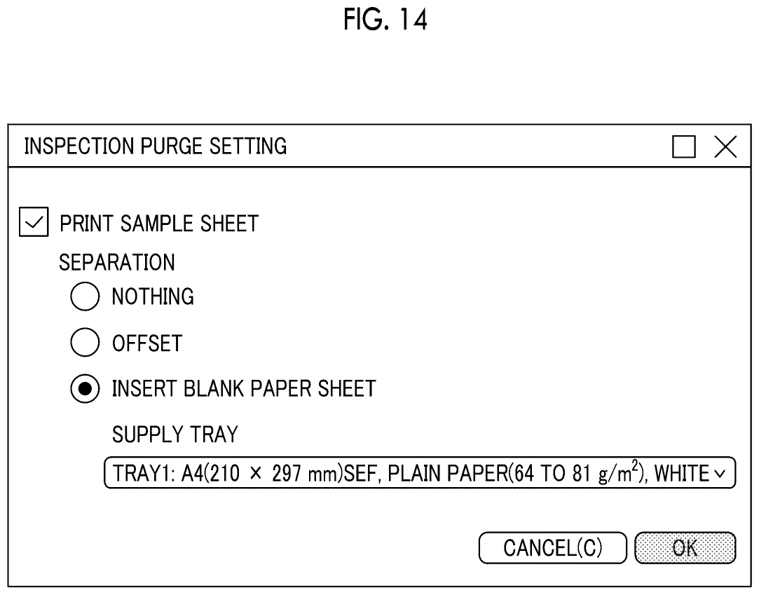

The purge setting is set in units of jobs from the UI 92 of the user terminal 90. FIG. 14 shows an example of a purge setting screen of a job to be inspected displayed on the display unit 96. The purge setting is performed by the user selecting a radio button on the purge setting screen by using the input unit 94. The purge setting screen and the selection method are examples and are not limited thereto.

First, a selection is made as to whether or not a sample printing is to be performed for the job to be inspected. In a case of performing sample printing, “Print sample sheet” is checked. In a case where sample printing is not performed, the check of “Print sample sheet” is removed.

Next, in a case of performing sample printing, the setting of the separation between the failed printed material and the printed material of the sample printing is selected. In a case where printing is continued without inserting separation between the failed printed material and the printed material of the sample printing, a check is put in “nothing”. In a case of inserting separation between the failed printed material and the printed material of the sample printing, any one of “offset” (making the discharge positions of the failed printed material and the printed material of the sample printing different) or “insert blank paper sheet” (discharging blank paper between the failed printed material and the printed material of the sample printing) is selected. These pieces of selected information are recorded in the print condition C.

The job J and the print condition C input from the UI 92 are transmitted from the user terminal 90 to the print control device 80, and a job that is a target of sample printing is printed in accordance with the setting of the print condition C.

### Sample Printing Process of Image Forming System

Next, a sample printing process by the image forming system 10 will be described.

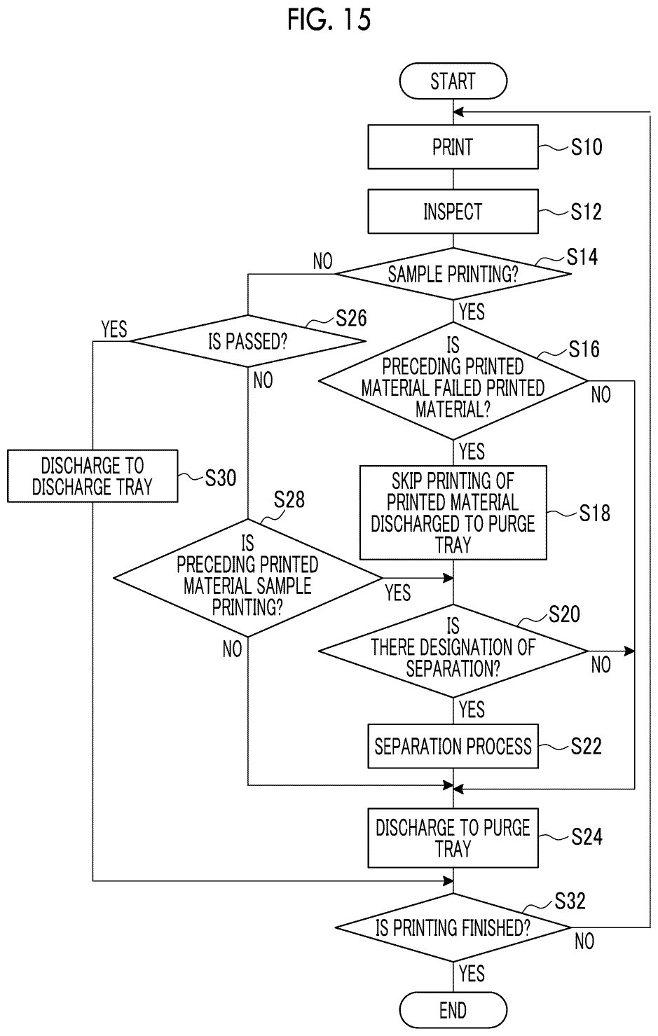

In a case where the image forming system 10 executes continuous printing of a plurality of printed materials and the printing device 20 receives an instruction for sample printing from the input unit 58, the image forming system 10 executes a sample printing process shown in FIG. 15.

First, in step S10, the CPU 50 performs printing or reprinting on the paper supplied from the supply unit 24. Subsequently, in step S12, the printed material that has been printed or reprinted or the printing quality of the reprinted material is inspected.

Next, in step S14, the CPU 50 determines whether or not the printed material is the target of sample printing. In a case of the target of sample printing (YES in step S14), the CPU 50 proceeds to step S16, and the CPU 50 determines whether or not the preceding printed material discharged to the purge tray 30T is the failed printed material.

In step S16, in a case where the failed printed material is not discharged to the purge tray 30T (NO in step S16), the process proceeds to step S24, and the printed material of the sample printing is discharged to the purge tray.

On the other hand, in a case where the preceding printed material discharged to the purge tray 30T is the failed printed material (YES in step S16), the CPU 50 proceeds to step S18.

In step S18, in a case where the printed material of the sample printing is included in the failed printed material discharged to the purge tray 30T, the CPU 50 skips the discharge of the printed material of the sample printing that has been printed (see 1P/2 and 2P/2 in FIG. 12). In step S10, the CPU 50 determines whether or not to perform reprinting, skips the sample printing that has been discharged as the failed printed material by the reprinting, and performs the printing on the next printed material (3P/2 in FIG. 12).

Next, in step S20, the CPU 50 determines whether or not the designation of separation is set in the print condition C. In a case where separation is not designated (NO in step S20), the process proceeds to step S24, and the CPU 50 discharges the printed material of the sample printing to the purge tray 30T.

On the other hand, in a case where the designation of separation is set in the print condition C (YES in step S20), the CPU 50 proceeds to step S22. In a case where the designation of separation is the insertion of blank paper, the CPU 50 discharges the blank paper into the purge tray 30T. Alternatively, in a case where the designation of separation is offset, the CPU 50 changes the discharge position of the purge tray 30T.

Subsequently, in step S24, the CPU 50 discharges the printed material of the sample printing to the purge tray 30T.

Returning to step S14, a case where the printed material is not the target of the sample printing will be described.

In step S14, in a case where it is determined that the printed material is not a target of the sample printing (NO in step S14), the process proceeds to step S26. In step S26, the CPU 50 determines whether or not the inspection result of the printed material performed in step S12 is passed or failed. In a case where the inspection result of the printed material is pass (YES in step S26), the CPU 50 proceeds to step S30 and discharges the passed printed material (not a target of sample printing) to the discharge tray 40T.

On the other hand, in a case where the inspection result of the printed material is failed in step S26 (NO in step S26), the CPU 50 proceeds to step S28.

In step S28, the CPU 50 determines whether or not the preceding printed material discharged to the purge tray 30T is the printed material of the sample printing. In a case where the preceding printed material is not the sample printing, and the failed printed material is discharged to the purge tray 30T (NO in step S28), the process proceeds to step S24, and the failed printed material is continuously discharged to the purge tray 30T.

On the other hand, in a case where the preceding printed material discharged to the purge tray 30T is the sample printing (YES in step S28), the process proceeds to step S20.

In step S20, the CPU 50 determines whether or not the designation of separation is set in the print condition C. In a case where the designation of separation is not made (NO in step S20), the process proceeds to step S24. In step S24, the CPU 50 discharges the failed printed material to the purge tray 30T, on the printed material of the sample printing loaded on the purge tray 30T.

In a case where the designation of separation is set in the print condition C (YES in step S20), the CPU 50 proceeds to step S22. In step S22, in a case where the designation of separation is the insertion of blank paper, the CPU 50 discharges the blank paper to the purge tray 30T. On the other hand, in a case where the designation of separation is the offset, the CPU 50 changes the discharge position of the purge tray 30T.

Subsequently, in step S24, the CPU 50 discharges the failed printed material (not a target of the sample printing) to the purge tray 30T.

In step S26, it is determined whether or not printing is finished. In a case where the printing is not finished (NO in step S26), the CPU 50 returns to step S10 and performs printing on the next printed material or reprinted material.

Until it is determined in step S26 that the printing is finished, steps S10 to S30 are repeated.

As described above, by printing the printed material to be inspected as a sample, the printing state can be visually checked. In addition, by inserting separation between the sample printing and the failed printing, it is possible to distinguish between the sample printing and the failed printing

In the above-described exemplary embodiment, a case where one part of the printed material of the job being printed is the target of the sample printing in a case where the instruction of the sample printing is received has been described, but for example, the sample printing may be performed at a designated interval such as 50 sets or 100 sets.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above exemplary embodiment, the mode in which each program is installed in the computer has been described, but the present invention is not limited to this. Each program according to the above exemplary embodiment may be provided in the form of a recording on a computer readable storage medium. For example, each program according to the above exemplary embodiment may be provided in the form of a recording on an optical disc such as a compact disc (CD)-ROM and a digital versatile disc (DVD)-ROM or in the form of a recording on a semiconductor memory such as a universal serial bus (USB) memory and a memory card. Further, each program according to the above-described exemplary embodiment may be acquired from an external apparatus via a communication I/F.

In addition, in the exemplary embodiment described above, a case where the processing in the image forming system 10 is implemented by a software configuration by using a computer by executing a program is described, but the present disclosure is not limited thereto. For example, the processing in the image forming system 10 may be implemented by a hardware configuration or a combination of the hardware configuration and the software configuration.

Further, needless to say, the configuration of the image forming system 10 described in the exemplary embodiment described above is an example, and an unnecessary part may be deleted or a new part may be added without departing from the gist of the present disclosure.

In addition, needless to say, the flow of the processes in the image forming system 10 described in the above exemplary embodiment is also an example, and an unnecessary step may be deleted, a new step may be added, or processing order may be changed without departing from the gist of the present disclosure.

The following supplementary notes are further disclosed regarding the above-described exemplary embodiment.

(((1)))

An information processing system comprising:
a processor configured to:
   inspect a printing quality of a printed material and perform continuous printing of a subsequent printed material;
   discharge a printed material having an inspection result of fail and a printed material printed until printing is stopped after the printed material having the inspection result of fail, as failed printed materials, to a first discharge unit;
   discharge a printed material having an inspection result of pass to a second discharge unit; and
   discharge a printed material to which an instruction of sample printing is given, as sample printing, to the first discharge unit, in a case where the instruction is received.
      (((2)))

The information processing system according to (((1))), wherein the processor is configured to:
discharge the printed material to which the instruction is given as the sample printing to the first discharge unit, only in a case where the printed material of the instruction is not included in the failed printed material.
   (((3)))

The information processing system according to (((1))) or (((2))), wherein the processor is configured to:
automatically resume the continuous printing from the printed material having the inspection result of fail.
   (((4)))

The information processing system according to (((3))), wherein the processor is configured to:
resume the continuous printing except for the printed material discharged to the first discharge unit among printed materials of the sample printing, in a case where the continuous printing is automatically resumed.
   (((5)))

The information processing system according to (((3))), wherein the processor is configured to:
discharge blank paper to the first discharge unit, between the printed material of the sample printing and the failed printed material.
   (((6)))

The information processing system according to (((5))), wherein the processor is configured to:
discharge the printed material of the sample printing to the first discharge unit after discharging the blank paper to the first discharge unit, in a case where the failed printed material is discharged to the first discharge unit before the printed material of the sample printing; and
discharge the failed printed material to the first discharge unit after discharging the blank paper to the first discharge unit, in a case where the printed material of the sample printing is discharged to the first discharge unit before the failed printed material.
   (((7)))

The information processing system according to any one of (((1))) to (((6))), wherein the processor is configured to:
change a position of a printed material to be discharged to the first discharge unit between the printed material of the sample printing and the failed printed material.
   (((8)))

The information processing system according to (((7))), wherein the processor is configured to:
make a position at which the printed material of the sample printing is discharged to the first discharge unit different from a position of the failed printed material discharged to the first discharge unit, in a case where the failed printed material is discharged to the first discharge unit before the sample printing; and
make a position at which the failed printed material is discharged to the first discharge unit different from a position of the printed material of the sample printing discharged to the first discharge unit, in a case where the printed material of the sample printing is discharged to the first discharge unit before the failed printed material.
   (((9)))

The information processing system according to any one of (((3))) to (((6)))), wherein the processor is configured to:
receive a user input to set a printing method corresponding to separation between the printed material of the sample printing and the failed printed material; and
discharge the printed material of the sample printing and the failed printed material to
   (((10)))

An information processing program causing a computer to execute a process comprising:
inspecting a printing quality of a printed material and printing a subsequent printed material;
discharging a printed material having an inspection result of fail and a printed material printed until printing is stopped after the printed material having the inspection result of fail, as failed printed materials, to a first discharge unit;
discharging a printed material having an inspection result of pass to a second discharge unit; and
discharging a printed material to which an instruction of sample printing is given, as sample printing, to the first discharge unit, in a case where the instruction is received.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
inspect a printing quality of a printed material and perform continuous printing of a subsequent printed material;
discharge a printed material having an inspection result of fail and a printed material printed until printing is stopped after the printed material having the inspection result of fail, as failed printed materials, to a first discharge unit;
discharge a printed material having an inspection result of pass to a second discharge unit; and
discharge a printed material to which an instruction of sample printing is given, as sample printing, to the first discharge unit, in a case where the instruction is received.

2. The information processing system according to claim 1, wherein the processor is configured to:
discharge the printed material to which the instruction is given as the sample printing to the first discharge unit, only in a case where the printed material of the instruction is not included in the failed printed material.

3. The information processing system according to claim 2, wherein the processor is configured to:
automatically resume the continuous printing from the printed material having the inspection result of fail.

4. The information processing system according to claim 3, wherein the processor is configured to:
resume the continuous printing except for the printed material discharged to the first discharge unit among printed materials of the sample printing, in a case where the continuous printing is automatically resumed.

5. The information processing system according to claim 3, wherein the processor is configured to:
discharge blank paper to the first discharge unit, between the printed material of the sample printing and the failed printed material.

6. The information processing system according to claim 5, wherein the processor is configured to:
discharge the printed material of the sample printing to the first discharge unit after discharging the blank paper to the first discharge unit, in a case where the failed printed material is discharged to the first discharge unit before the printed material of the sample printing; and
discharge the failed printed material to the first discharge unit after discharging the blank paper to the first discharge unit, in a case where the printed material of the sample printing is discharged to the first discharge unit before the failed printed material.

7. The information processing system according to claim 3, wherein the processor is configured to:
change a position of a printed material to be discharged to the first discharge unit between the printed material of the sample printing and the failed printed material.

8. The information processing system according to claim 7, wherein the processor is configured to:
make a position at which the printed material of the sample printing is discharged to the first discharge unit different from a position of the failed printed material discharged to the first discharge unit, in a case where the failed printed material is discharged to the first discharge unit before the sample printing; and
make a position at which the failed printed material is discharged to the first discharge unit different from a position of the printed material of the sample printing discharged to the first discharge unit, in a case where the printed material of the sample printing is discharged to the first discharge unit before the failed printed material.

9. The information processing system according to claim 3, wherein the processor is configured to:
receive a user input to set a printing method corresponding to separation between the printed material of the sample printing and the failed printed material; and
discharge the printed material of the sample printing and the failed printed material to

10. The information processing system according to claim 4, wherein the processor is configured to:
receive a user input to set a printing method corresponding to separation between the printed material of the sample printing and the failed printed material; and
discharge the printed material of the sample printing and the failed printed material to the first discharge unit in accordance with the set printing method.

11. The information processing system according to claim 5, wherein the processor is configured to:
receive a user input to set a printing method corresponding to separation between the printed material of the sample printing and the failed printed material; and
discharge the printed material of the sample printing and the failed printed material to the first discharge unit in accordance with the set printing method.

12. The information processing system according to claim 6, wherein the processor is configured to:
receive a user input to set a printing method corresponding to separation between the printed material of the sample printing and the failed printed material; and
discharge the printed material of the sample printing and the failed printed material to the first discharge unit in accordance with the set printing method.

13. A non-transitory computer readable medium storing an information processing program causing a computer to execute a process comprising:
inspecting a printing quality of a printed material and printing a subsequent printed material;
discharging a printed material having an inspection result of fail and a printed material printed until printing is stopped after the printed material having the inspection result of fail, as failed printed materials, to a first discharge unit;
discharging a printed material having an inspection result of pass to a second discharge unit; and
discharging a printed material to which an instruction of sample printing is given, as sample printing, to the first discharge unit, in a case where the instruction is received.

14. An information processing method comprising:
inspecting a printing quality of a printed material and printing a subsequent printed material;
discharging a printed material having an inspection result of fail and a printed material printed until printing is stopped after the printed material having the inspection result of fail, as failed printed materials, to a first discharge unit;
discharging a printed material having an inspection result of pass to a second discharge unit; and
discharging a printed material to which an instruction of sample printing is given, as sample printing, to the first discharge unit, in a case where the instruction is received.
